(19) United States
(12) Patent Application Publication
(10) Pub. No.: US 2012/0134782 A1
(43) Pub. Date: May 31, 2012

(54) PURGE SYSTEMS FOR ROTARY MACHINES AND METHODS OF ASSEMBLING SAME

(76) Inventors: Creston Lewis Dempsey, Mauldin, SC (US); Seung-Woo Choi, Greer, SC (US); Raymond Joseph Lecuyer, Taylors, SC (US); Matthew Ryan Ferslew, Johnson City, TN (US); Jong Youn Pak, Oakland Township, MI (US); Josef Scott Cummins, Simpsonville, SC (US)

(21) Appl. No.: 12/956,356

(22) Filed: Nov. 30, 2010

(51) Int. Cl. F01D 17/00; B23P 19/00

(52) U.S. Cl. 415/145; 29/700

(57) ABSTRACT

A method for assembling a rotary machine includes providing a first rotatable element. The method also includes coupling a second rotatable element to the first rotatable element. The first rotatable element and the second rotatable element at least partially define a cavity therein and at least one conduit extending substantially axially therebetween. Further, the method includes coupling a purge device including at least one radial channel defined therein and extending to the first rotatable element and to the second rotatable element such that the at least one radial channel is coupled in flow communication with the cavity and with the at least one axial conduit.

### BACKGROUND OF THE INVENTION

The embodiments described herein relate generally to rotary machines and, more particularly, to fluid purge systems used with gas turbine compressors.

Known gas turbine systems include a compressor section that compresses air channeled through the turbine system. During operation of at least some known gas turbine systems, at least some portions of the compressor sections may be subject to high stresses, vibrations, and/or temperatures. For example at least some known compressor sections include a plurality of stages coupled to a rotor that increasingly compresses air to higher pressures and, consequently, proportionally increases a temperature of air channeled therethrough. Such differences in airflow temperature may generate thermal gradients within the compressor section. Such thermal gradients may lead to uneven thermal expansion, bending, and/or other stresses, which over time could damage and/or reduce a life useful expectancy of some compressor components.

Moreover, at least some known compressor sections are coupled to, and/or positioned in the vicinity of, a combustor that ignites an air-fuel mixture to generate combustion gases. To improve an efficiency of at least some gas turbine systems, a compressor section discharge temperature, a combustor firing temperature, and/or a compressor section flow rate may be increased, any or all of which may undesirably intensify the generated thermal gradients within the compressor section.

### BRIEF SUMMARY OF THE INVENTION

In one aspect, a method for assembling a rotary machine is provided. The method includes providing a first rotatable element. The method also includes coupling a second rotatable element to the first rotatable element. The first rotatable element and the second rotatable element at least partially define a cavity therein and at least one conduit extending substantially axially therebetween. Further, the method includes coupling a purge device including at least one radial channel defined therein and extending to the first rotatable element and to the second rotatable element such that the at least one radial channel is coupled in flow communication with the cavity and with the at least one axial conduit.

In a further aspect, a purge system for a rotary machine is provided. The purge system includes a purge device coupled to a first rotatable element and to a second rotatable element that is coupled to the first rotatable element such that at least one cavity is at least partially defined by the first rotatable element and the second rotatable element. The purge system also includes at least one axial fluid supply conduit coupled in flow communication with the purge device. The purge device includes at least one radial channel defined therein. The at least one radial channel is coupled in flow communication with the at least one axial fluid supply conduit and with the at least one cavity.

In another aspect, a turbine engine is provided. The turbine engine includes a forward compressor rotor. The turbine engine also includes an aft compressor rotor rotatably coupled to the forward compressor rotor. The aft compressor rotor and the forward compressor rotor at least partially define a cavity therein and at least one axial conduit that extends substantially axially therebetween. The turbine engine also includes a purge device coupled to the forward compressor rotor and the aft compressor rotor. The purge device further defines the cavity at least partially defined by the aft compressor rotor and the forward compressor rotor. The purge device also further defines the at least one axial conduit at least partially defined by the aft compressor rotor and the forward compressor rotor. The purge device also includes at least one radial channel. The at least one radial channel is coupled in flow communication with the at least one axial conduit and the cavity.

### BRIEF DESCRIPTION OF THE DRAWINGS

The embodiments described herein may be better understood by referring to the following description in conjunction with the accompanying drawings.

FIG. 1 is schematic diagram of an exemplary turbine engine;

FIG. 2 is an enlarged cross-sectional view of a portion of the turbine engine shown in FIG. 1 and taken along area 2;

FIG. 3 is a perspective view of an exemplary purge ring that may be used with the turbine engine shown in FIG. 1;

FIG. 4 is a cross-sectional view of the portion of the turbine engine shown in FIG. 2 with air flows added; and

FIG. 5 is a flow chart illustrating an exemplary method of assembling a portion of the turbine engine shown in FIG. 1.

### DETAILED DESCRIPTION OF THE INVENTION

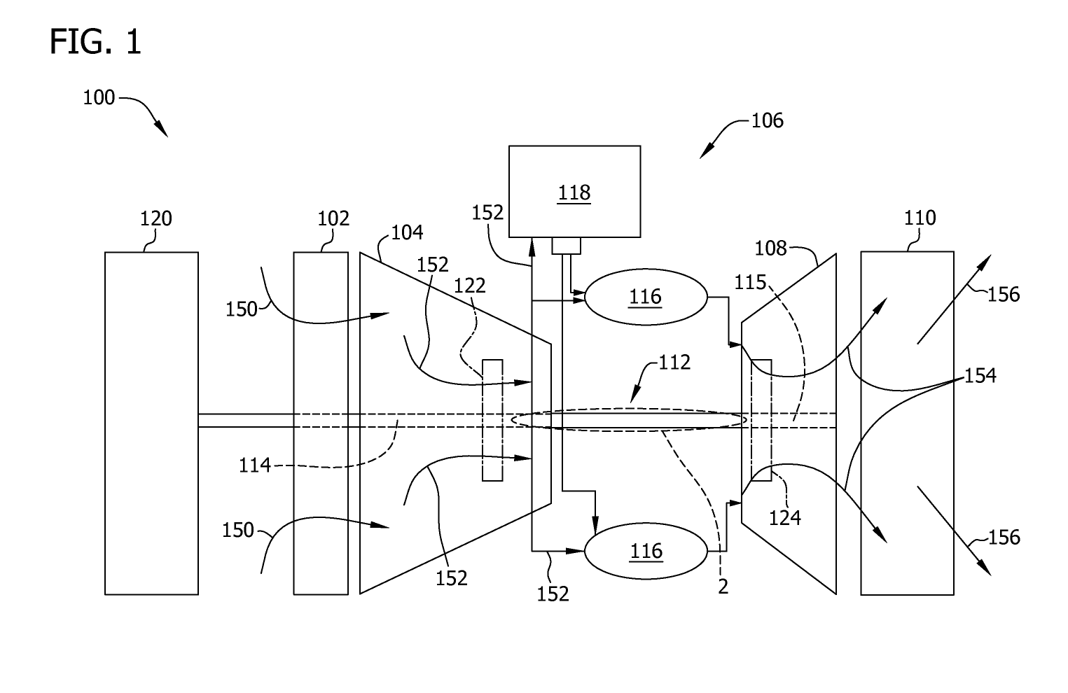

FIG. 1 is a schematic view of a rotary machine 100, i.e., a turbomachine, and more specifically, a turbine engine. In the exemplary embodiment, turbine engine 100 is a gas turbine engine. Alternatively, it should be noted that those skilled in the art will understand that other engines may be used. In the exemplary embodiment, turbine engine 100 includes an air intake section 102, and a compressor section 104 that is coupled downstream from, and in flow communication with, intake section 102. A combustor section 106 is coupled downstream from, and in flow communication with, compressor section 104, and a turbine section 108 is coupled downstream from, and in flow communication with, combustor section 106. Turbine engine 100 includes an exhaust section 110 that is downstream from turbine section 108. Moreover, in the exemplary embodiment, turbine section 108 is coupled to compressor section 104 via a rotor assembly 112 that includes, without limitation, a compressor rotor, or drive shaft 114 and a turbine rotor, or drive shaft 115.

In the exemplary embodiment, combustor section 106 includes a plurality of combustor assemblies, i.e., combustors 116 that are coupled each in flow communication with compressor section 104. Combustor section 106 also includes at least one fuel nozzle assembly 118. Each combustor 116 is in flow communication with at least one fuel nozzle assembly 118. Moreover, in the exemplary embodiment, turbine section 108 and compressor section 104 are rotatably coupled to a load 120 via drive shaft 114. For example, load 120 may include, without limitation, an electrical generator and/or a mechanical drive application, e.g., a pump. In the exemplary embodiment, compressor section 104 includes at least one compressor blade assembly 122. Also, in the exemplary embodiment, turbine section 108 includes at least one turbine blade or bucket mechanism 124. Each compressor blade assembly 122 and each turbine bucket mechanism 124 is coupled to rotor assembly 112, or, more specifically, compressor drive shaft 114 and turbine drive shaft 115.

In operation, air intake section 102 channels air 150 towards compressor section 104. Compressor section 104 compresses inlet air 150 to higher pressures and temperatures prior to discharging compressed air 152 towards combustor section 106. Compressed air 152 is mixed with fuel (not shown) and ignited within section 106 to generate combustion gases 154 that are channeled downstream towards turbine section 108. Specifically, at least a portion of compressed air 152 is channeled to fuel nozzle assembly 118. Fuel is also channeled to fuel nozzle assembly 118, wherein the fuel is mixed with compressed air 152 and the mixture is ignited within combustors 116. Combustion gases 154 generated within combustors 116 are channeled downstream towards turbine section 108. After impinging turbine bucket mechanisms 124, thermal energy is converted to mechanical rotational energy that is used to drive rotor assembly 112. Turbine section 108 drives compressor section 104 and/or load 120 via drive shafts 114 and 115, and exhaust gases 156 are discharged through exhaust section 110 to ambient atmosphere.

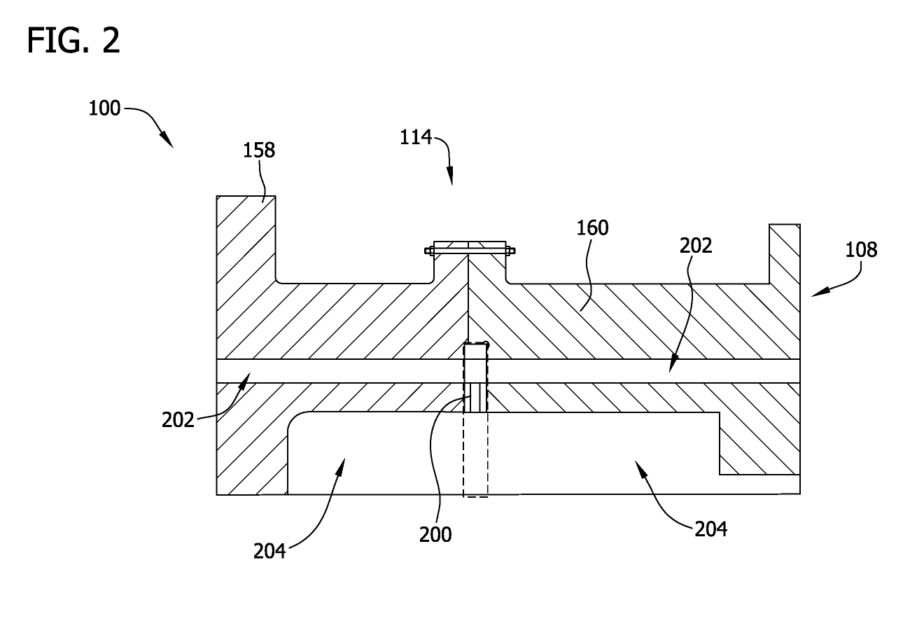

FIG. 2 is an enlarged cross-sectional view of a portion of turbine engine 100 taken along area 2 (shown in FIG. 1). In the exemplary embodiment, compressor drive shaft 114 includes a first rotatable element, i.e., a forward compressor rotor, or drive shaft 158, that is rotatably coupled to a second rotatable element, i.e., an aft compressor rotor, or drive shaft 160. Aft compressor drive shaft 160 is rotatably coupled to a third rotatable element, i.e., turbine drive shaft 115. Also, in the exemplary embodiment, a purge device, i.e., a purge ring 200 is coupled to forward compressor drive shaft 158 and to aft compressor drive shaft 160. Further, in the exemplary embodiment, purge ring 200 and aft compressor drive shaft 160 at least partially form rotor assembly 112 with compressor drive shaft 114 and turbine drive shaft 115. Moreover, in the exemplary embodiment, at least one axial fluid supply conduit, i.e., bucket cooling air supply conduit 202 (only one shown in FIG. 2) is defined by forward compressor drive shaft 158, aft compressor drive shaft 160, and purge ring 200. Bucket cooling air supply conduit 202 channels cooling air (not shown in FIG. 2) from compressor section 104 towards turbine bucket mechanisms 124 (shown in FIG. 1). Also, in the exemplary embodiment, a cavity 204 is defined by forward compressor drive shaft 158, aft compressor drive shaft 160, and purge ring 200. Further, in the exemplary embodiment, a purge ring cavity 206 defined within aft compressor drive shaft 160 is sized and oriented to receive purge ring 200. Alternatively, a portion of purge ring cavity 206 may also be defined within a portion of forward compressor drive shaft 158.

In the exemplary embodiment, purge ring 200 is a separate component that is rotatably coupled to adjacent components, i.e., forward compressor drive shaft 158 and aft compressor drive shaft 160, using, for example, an interference or friction fit. Alternatively, purge ring 200 may be coupled to forward compressor drive shaft 158 and aft compressor drive shaft 160 using any coupling means that enables of purge ring 200 and gas turbine engine 100 to function as described herein including, without limitation, mechanical fastening hardware. In another alternative embodiment, purge ring 200, may be formed unitarily with any existing component(s) that enables gas turbine engine 100 to function as described herein.

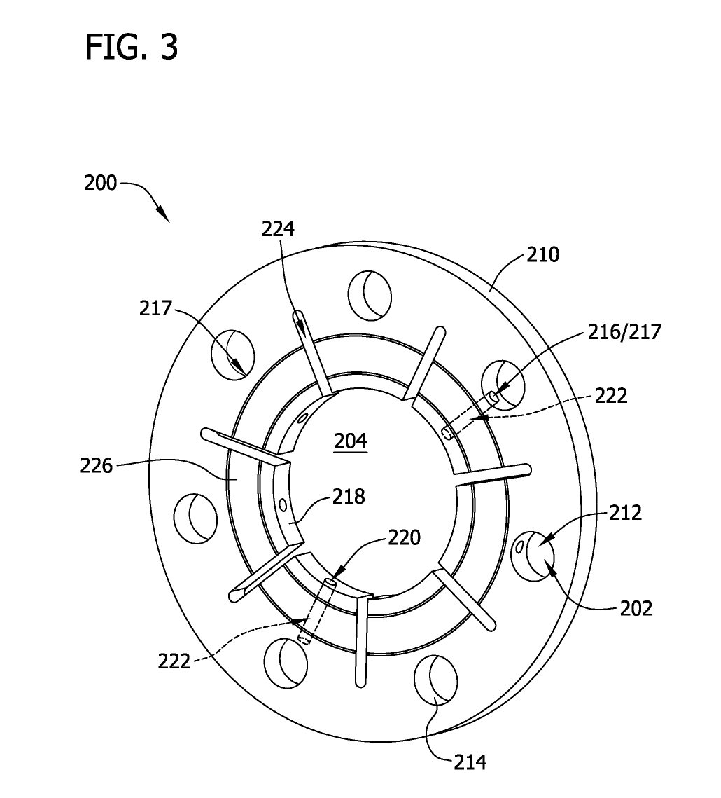

FIG. 3 is a perspective view of purge ring 200. In the exemplary embodiment, purge ring 200 increases a substantially circular rim 210 and a plurality of axial cooling conduits 212 that each partially define a portion of a bucket cooling air supply conduit 202. More specifically, each cooling conduit 212 is defined by conduit wall 214. Each cooling conduit wall 214 also defines a cooling air diverting inlet 216 in a radially innermost portion 217 of wall 214. Each cooling air diverting inlet 216 is sized and oriented to divert at least a portion of cooling air (not shown in FIG. 3) from each associated bucket cooling air supply conduit 202 towards cavity 204.

In the exemplary embodiment, purge ring 200 increases a plurality of radially inner surfaces 218. Each surface 218 defines a cooling air diverting outlet 220 that is in flow communication with an associated cooling air diverting inlet 216 via a cooling air diverting channel 222 defined therebetween. Also, in the exemplary embodiment, radially inner surfaces 218 at least partially define cavity 204.

Moreover, in the exemplary embodiment, each purge ring 200 includes a plurality of stress shield, or stress slots 224 that facilitate reducing stresses induced into purge ring 200 and reducing rabbet interference with respect to insertion and removal of purge ring 200 into and from purge ring cavity 206 (shown in FIG. 2). In the exemplary embodiment, anti-rotation pins (not shown) may be inserted through stress slots 224 into forward compressor drive shaft 158 and/or aft compressor drive shaft 160 (both shown in FIG. 2) to secure purge ring 200 within purge ring cavity 206. Stress slots 224 include a plurality of partially frustoconical segments 226 defined therebetween.

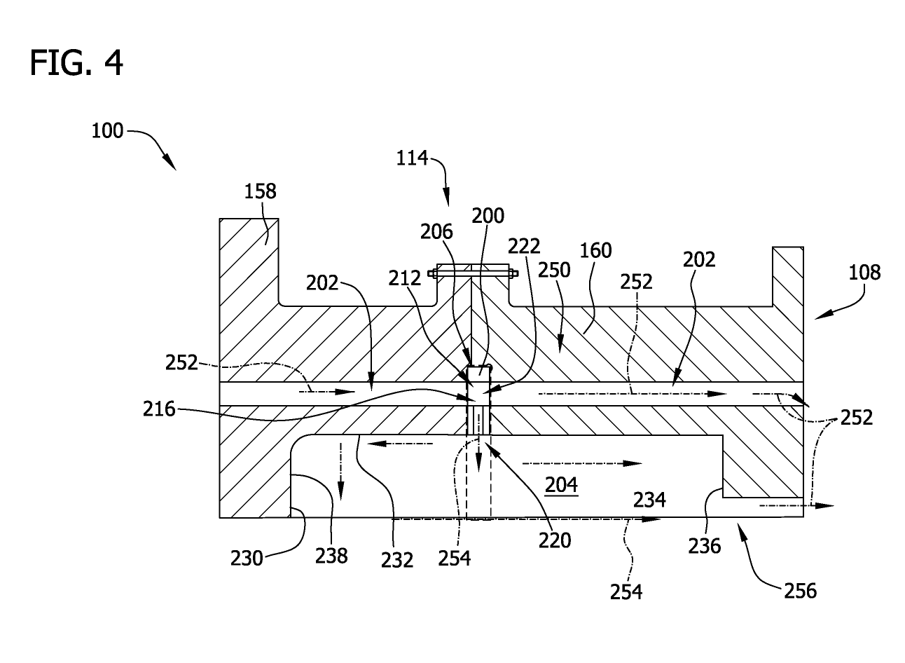

FIG. 4 is a cross-sectional view of the portion of turbine engine 100 shown in FIG. 2 with air flow arrows 252 and 254 added. As described above, cavity 204 is at least partially defined by forward compressor drive shaft 158, aft compressor drive shaft 160, and purge ring 200. More specifically, in the exemplary embodiment, cavity 204 is defined by a compressor radial wall 230, a compressor axial wall 232, an aft compressor drive shaft axial wall 234, and an aft compressor drive shaft radial wall 236. At least one wall 230, 232, 234, and/or 236 includes a stress limiting portion 238 (only one shown in FIG. 4). Primary heat removal from walls 230, 232, 234, and/or 236, including each stress limiting portion 238, facilitates reducing thermal stresses induced in each wall 230, 232, 234, and/or 236.

In the exemplary embodiment, purge ring 200, and more specifically, axial cooling conduits 212, cooling air diverting inlets 216, cooling air diverting channels 222, cooling air diverting outlets 220, and cavity 204 cooperate and form a cavity purge system 250. Also, in the exemplary embodiment, bucket cooling air supply conduits 202 and cavity purge system 250, including axial cooling conduits 212, cooling air diverting inlets 216, cooling air diverting channels 222, cooling air diverting outlets 220, and cavity 204 have any sizing and any orientation that enables operation of cavity purge system 250 and gas turbine engine 100 as described herein.

In operation, turbine bucket cooling air flow 252 is channeled through air supply conduits 202 from forward compressor drive shaft 158 and aftward towards turbine section 108. A portion of air flow 252 is diverted, or channeled into purge ring 200 via cooling air diverting inlets 216 and from conduits 212, thereby forming a cavity cooling air flow 254. Air flow 254 is channeled through air diverting channels 222 and air diverting outlets 220 into cavity 204, wherein cooling air 254 facilitates removal of heat from walls 230, 232, 234, and 236, including stress limiting portions 238, and thus facilitates reducing of thermal stresses induced therein. Cooling air 254 is channeled aftward through a cavity through-port 256, to facilitate cooling in turbine section 108.

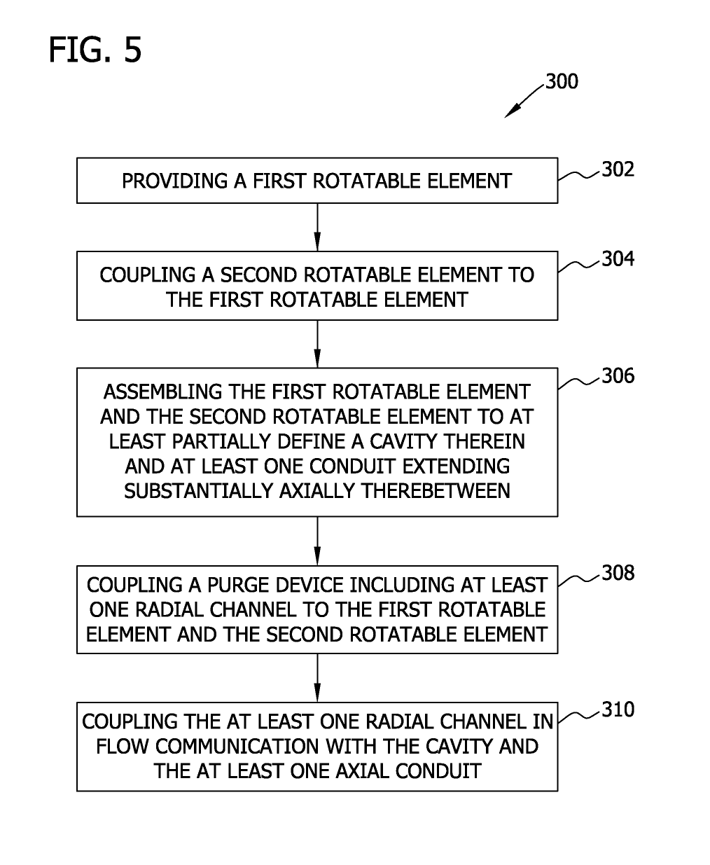

FIG. 5 is a flow chart illustrating an exemplary method 300 that may be used in assembling a portion of turbine engine 100 (shown in FIGS. 1, 2, and 4). In the exemplary embodiment, a first rotatable element, i.e., forward compressor drive shaft 158 (shown in FIGS. 2 and 4) is provided 302. Also, in the exemplary embodiment, a second rotatable element, i.e., aft compressor drive shaft 160 (shown in FIGS. 2 and 4) is coupled 304 to forward compressor drive shaft 158. Forward compressor drive shaft 158 and aft compressor drive shaft 160 are assembled 306 to at least partially define a cavity, i.e., cavity 204 (shown in FIGS. 2, 3, and 4) therein. Cavity 204 extends between at least one axial conduit, i.e., bucket cooling air supply conduits 202 (shown in FIGS. 2 and 4), wherein conduits 202 extend substantially axially between forward compressor drive shaft 158 and aft compressor drive shaft 160. Further, in the exemplary embodiment, a purge device, i.e., purge ring 200 (shown in FIGS. 2, 3, and 4) including at least one radial channel, i.e., cooling air diverting channels 222 (shown in FIGS. 3 and 4) is rotatably coupled 308 to forward compressor drive shaft 158 and aft compressor drive shaft 160. Cooling air diverting channels 222 are coupled 310 in flow communication with cavity 204 and bucket cooling air supply conduits 202.

Embodiments of turbomachine fluid purge systems and devices as provided herein facilitate the assembly and operation of turbine engines using fluid compressors rotatably coupled to a turbine. Such fluid purge devices facilitate assembly and disassembly of the turbomachine by avoiding use of additional mechanical fastening hardware. Also, such fluid purge systems and devices facilitate improving cooling fluid flow to compressor components that are exposed to thermal gradients. The improved cooling fluid flow facilitates improving a thermal response of compressor components that are exposed to the thermal gradients that induce significant stresses therein as compared to most known compressor sections. These improved thermal responses include smaller thermal gradients that reduce a potential for uneven expansion and/or bending. Therefore, the improved thermal responses extend a structural life cycle of the affected components as compared to most known compressor sections. Moreover, the improved thermal responses extend facilitate improving a service life of such components and reducing maintenance repair costs and reducing periods wherein the turbomachine is removed from service as compared to most known turbomachines.

Described herein are exemplary embodiments of methods and apparatus that facilitate assembly and operation of gas turbine engines. Specifically, assembling gas turbine engines with a purge/heat removal system and associated apparatus facilitates channeling a cooling fluid, i.e., air into predetermined cavities and about predetermined components to improve a thermal response therein. More specifically, redirecting a portion of existing turbine bucket cooling air to a cavity region facilitates a reduction in thermal gradients and stresses induced within the components that form the region. Therefore, the reduced stresses and improved thermal responses extend a structural life cycle of the affected components, thereby improving a service life of such components and reducing maintenance repair costs and reducing a length and frequency of periods wherein the turbomachine is removed from service.

The methods and systems described herein are not limited to the specific embodiments described herein. For example, components of each system and/or steps of each method may be used and/or practiced independently and separately from other components and/or steps described herein. In addition, each component and/or step may also be used and/or practiced with other assemblies and methods.

While the invention has been described in terms of various specific embodiments, those skilled in the art will recognize that the invention can be practiced with modification within the spirit and scope of the claims.

What is claimed is:

1. A method for assembling a rotary machine, said method comprising:
providing a first rotatable element;
coupling a second rotatable element to the first rotatable element such that the first rotatable element and the second rotatable element at least partially define a cavity therein, and at least one conduit that extends substantially axially therebetween; and
coupling a purge device including at least one radial channel defined therein and extending to the first rotatable element and to the second rotatable element such that the at least one radial channel is coupled in flow communication with the cavity and with the at least one axial conduit.

2. A method in accordance with claim 1, wherein the first rotatable element is a forward compressor rotor and the second rotatable element is an aft compressor rotor.

3. A method in accordance with claim 2, wherein coupling a purge device comprises coupling the purge device to the forward compressor rotor and the aft compressor rotor.

4. A method in accordance with claim 3, wherein coupling the purge device between the forward compressor rotor and the aft compressor rotor comprises further defining the cavity therein.

5. A method in accordance with claim 4, wherein coupling the purge device between the forward compressor rotor and the aft compressor rotor comprises further defining the at least one axial conduit, thereby defining a plurality of axial conduits extending therebetween.

6. A method in accordance with claim 1, wherein coupling a purge device comprises forming a cavity purge system that includes a plurality of radial cooling fluid flow channels coupled in flow communication with a plurality of axial cooling fluid flow conduits and the cavity.

7. A method in accordance with claim 6, wherein forming a cavity purge system further comprises forming the cavity purge system in parallel with and in flow communication with a turbine bucket cooling fluid flow conduit.

8. A purge system for a rotary machine, said purge system comprising:
a purge device coupled to a first rotatable element and to a second rotatable element coupled to the first rotatable element such that at least one cavity is at least partially defined by the first rotatable element and the second rotatable element; and
at least one axial fluid supply conduit coupled in flow communication with said purge device, said purge device comprises at least one radial channel defined therein, said at least one radial channel is coupled in flow communication with said at least one axial fluid supply conduit and with the at least one cavity.

9. A purge system in accordance with claim 8, wherein said purge device is rotatably coupled to each of a forward compressor rotor and an aft compressor rotor, wherein the forward compressor rotor is the first rotatable element and the aft compressor rotor is the second rotatable element.

10. A purge system in accordance with claim 8, wherein said purge device further defines at least a portion of the at least one cavity that is at least partially defined by the first rotatable element and the second rotatable element.

11. A purge system in accordance with claim 10, wherein the at least one cavity partially defined by said purge device, the first rotatable element, and the second rotatable element is a unitary cavity defined therein.

12. A purge system in accordance with claim 8, wherein said purge device is a purge ring at least partially defining a plurality of axial cooling conduits.

13. A purge system in accordance with claim 12, wherein said purge ring further comprises a plurality of radial cooling channels coupled in flow communication with said plurality of axial cooling conduits.

14. A purge system in accordance with claim 13, wherein said purge ring further comprises a plurality of slots radially extending from the cavity.

15. A turbine engine comprising:
a forward compressor rotor;
an aft compressor rotor rotatably coupled to said forward compressor rotor, said aft compressor rotor and said forward compressor rotor at least partially define a cavity therein, and at least one conduit that extends substantially axially therebetween; and
a purge device coupled to said forward compressor rotor and said aft compressor rotor, said purge device further defines said cavity at least partially defined by said aft compressor rotor and said forward compressor rotor, said purge device further defines said at least one axial conduit at least partially defined by said aft compressor rotor and said forward compressor rotor, said purge device also comprises at least one radial channel, wherein said at least one radial channel is coupled in flow communication with said at least one axial conduit and with said cavity.

16. A turbine engine in accordance with claim 15, wherein said cavity is coupled in flow communication with at least one turbine bucket cooling supply conduit.

17. A turbine engine in accordance with claim 15, wherein said purge device is a purge ring and said at least one axial conduit comprises a plurality of axial cooling conduits.

18. A turbine engine in accordance with claim 16, wherein said purge ring further comprises a plurality of slots radially extending from said cavity.

19. A turbine engine in accordance with claim 17, wherein said at least one radial channel defined by said purge ring comprises a plurality of radial cooling channels coupled in flow communication with said plurality of axial cooling conduits.

20. A turbine engine in accordance with claim 16, wherein said at least one turbine bucket cooling supply conduit is coupled in flow communication with said cavity via a plurality of radial cooling channels defined within said purge device and a plurality of axial cooling conduits defined within said purge device.
